(19) United States
(12) Patent Application Publication
(10) Pub. No.: US 2006/0065516 A1
(43) Pub. Date: Mar. 30, 2006

(54) Method of and apparatus for fabricating nano-sized carbon material

(76) Inventors: Tsugio Matsuura, Fukui (JP); Keiji Taniguchi, Fukui (JP)

Correspondence Address: FLYNN THIEL BOUTELL & TANIS, P.C., 2026 RAMBLING ROAD, KALAMAZOO, MI, 49008-1631, US

(21) Appl. No.: 11/123,869

(22) Filed: May 6, 2005

(30) Foreign Application Priority Data
May 6, 2004 (JP) 2004-137158
May 2, 2005 (JP) 2005-134686

(51) Int. Cl. C01B 31/00; B01J 19/08

(52) U.S. Cl. 204/173; 422/186

(57) ABSTRACT

It is an object of the invention to provide a method, and an apparatus, capable of fabricating a nano-sized carbon material excellent in quality by use of a three-dimensional discharge apparatus on a mass production basis. There are installed 12 pieces of discharge electrodes, 6 pieces each being horizontally disposed in two tiers, upper tier and lower tier, at a side face part of the discharge vessel. The 6 pieces of the discharge electrodes, in the upper tier and lower tier, respectively, are disposed so as to be angularly shifted by 60 degrees from each other along the horizontal plane, and it is set such that the respective discharge electrodes in the upper tier are disposed so as to be angularly shifted by 30 degrees from the respective discharge electrodes in lower tier as seen from above. ACs from an AC power source, having a phase difference being shifted from each other, are impressed on the 12 pieces of the discharge electrodes, respectively, and when the ACs are impressed on the discharge electrodes, respectively, an arc discharge is caused to occur between the respective discharge electrodes, thereby forming a plasma region in a region surrounded by the respective discharge electrodes. With the use of carbon electrodes for the discharge electrodes, vaporization of carbon from the discharge electrodes takes place owing to high temperature in the plasma region, thereby implementing synthesis of a high-impurity nano-sized carbon material.

### FIELD OF THE INVENTION

The invention relates to a method of and an apparatus for fabricating a nano-sized carbon material, such as fullerenes, carbon nanotubes, and so forth, by an arc discharging.

### BACKGROUND OF THE INVENTION

A nano-sized carbon material fabricated by controlling a structure of a matter at a nanometer (nm: one billionth of one meter) level has been known to exhibit novel physical properties and functions, and attempts are being made to make good use of the nano-sized carbon material in a wide variety of fields such as semiconductor devices, information communications, energy, catalysts, biotechnology, and so forth. Because the nano-sized carbon material has peculiar properties that the conventional carbon materials (graphite and diamond) do not have, development of technologies for mass production thereof has been under study. The nano-sized carbon material is an allotrope of carbon having a structure at a nanometer level, and includes single-layer carbon nanotubes, multilayer carbon nanotubes, fullerenes, carbon nanofibers, and carbon ultrafine particles.

As for fabrication of the nano-sized carbon material, for example, the fullerenes are fabricated by applying laser irradiation, arc discharging, or resistive heating to a carbon raw material, such as graphite, and so forth, to thereby produce carbon vapor, and by cooling the carbon vapor in an inert gas of helium, argon, or the like. In Patent Document 1, there has been described fabrication of fullerenes by applying a voltage from a DC power source to a pair of graphite electrodes in an atmosphere of an inert gas, thereby causing an arc discharge to occur.

Further, carbon nanotubes are fabricated by causing carbon electrodes to undergo an arc discharge in a helium gas, or by application of the chemical vapor deposition (CVD) method using acetylene, methane, and so forth, as a raw material gas. In Patent Document 2, there has been described fabrication of carbon nanotubes on a pair of carbon electrodes by vaporizing carbon through an arc discharging to be subsequently condensed. Furthermore, in Non-patent Documents 1 to 7, respectively, there has been described fabrication of carbon nanotubes similarly by applying a voltage from a DC power source to a pair of carbon electrodes, thereby causing an arc discharge to occur.

[Patent Document 1] Japanese Patent No. 3156287

[Patent Document 2] Japanese Patent No. 2845675

[Patent Document 3] Japanese Patent No. 3094217

[Non-patent Document 1] Kazunori Anazawa et al, High-purity carbon nanotubes synthes is method by an arc discharging in magnetic field, Applied Physics Letters, Vol. 81 No. 4, July 2002

[Non-patent Document 2] H. Takikawa et al, fabrication of single-walled carbon nanotubes and nanohorns by means of a torch are in open air, Physica B, 322, 2002, 277-279

[Non-patent Document 3] H. Takikawa et al, New simple method of carbon nanotube fabrication using welding torch, CP590, Nanonetwork Materials, American Institute of Physics 2001

[Non-patent Document 4] H. J. Lai et al, Synthesis of carbon nanotubes using polycyclic armatic hydrocarbons as carbon sources in an are discharge, Material Science and Engineering C 16, 2001, 23-26

[Non-patent Document 5] H. w. Zhu et al, Direct synthesis of long single-walled carbon nanotube strands, SCIENCE, Vol 296, 2002

[Non-patent Document 6] C. Journet et al, Large-scale production of single-walled carbon nanotubes by the electric-arc technique, NATURE, Vol. 388,

[Non-patent Document 7] Yahachi Saito, Carbon nanotubes produced by arc discharge, New Diamond and Carbon Technology, Vol. 9, No. 1, 1999

### SUMMARY OF THE INVENTION

### Problems to be Solved by the Invention

In the case of the above-described methods for fabricating the nano-sized carbon material, a method for fabrication by use of a CVD process is suitable for use from the viewpoint of mass production, however, with the method for fabrication by use of the CVD process, defects are prone to occur to the structure of the nano-sized carbon material as fabricated. Further with the method using the arc discharging, it is possible to fabricate a high-quality nano-sized carbon material with a few structural defects, however, because a discharge region between a pair of carbon electrodes is small in this case, it is difficult to implement mass production.

The inventors have succeeded in developing a three-dimensional discharge apparatus capable of forming a three-dimensional plasma region through arc discharging. As described in Patent Document 3, with a three-dimensional discharge apparatus as developed, 12-phase AC is generated through conversion of 3-phase AC, and the 12-phase AC as generated is impressed on 12 pieces of discharge electrodes, respectively, to cause a three-dimensional arc discharge to occur in a region surrounded by the discharge electrodes three-dimensionally disposed, thereby enabling a high-density, high-temperature, and homogeneous plasma region to be stably formed.

Accordingly, based on knowledge obtained from the three-dimensional discharge apparatus as developed, the inventors have succeeded in developing the invention of a method of and an apparatus, capable of fabricating a nano-sized carbon material excellent in quality on a mass production basis.

The invention provides a method of fabricating a nano-sized carbon material, comprising the steps of preparing not less than three pieces of discharge electrodes disposed in two dimensions or three dimensions, impressing ACs with a phase difference shifted from each other on the not less than three pieces of the discharge electrodes, respectively, in an insert gas atmosphere, thereby causing arc discharges to occur, and producing the nano-sized carbon material from a carbon raw material by use of a plasma region formed by the arc discharges. Further, the carbon raw material may be carbon contained in the discharge electrodes. Still further, the carbon raw material may be a raw material gas contained in the insert gas. Yet further, a metal material having a catalytic action is preferably used in producing the nano-sized carbon material.

The invention provides an apparatus for fabricating a nano-sized carbon material comprising a discharge vessel where not less than three pieces of carbon discharge electrodes are disposed in two dimensions or three dimensions, a gas feeder for feeding an inert gas into the discharge vessel, and an AC power source for impressing ACs with a phase difference shifted from each other on the carbon discharge electrodes, respectively, thereby causing an arc discharge to occur between the respective carbon discharge electrodes.

Further, the invention provides another apparatus for fabricating a nano-sized carbon material comprising a discharge vessel where not less than three pieces of discharge electrodes are disposed in two dimensions or three dimensions, a gas feeder for feeding an inert gas containing a raw material gas into the discharge vessel, and an AC power source for impressing ACs with a phase difference shifted from each other on the discharge electrodes, respectively, thereby causing an arc discharge to occur between the respective discharge electrodes.

Still further, with any of the above-described apparatus for fabricating the nano-sized carbon material, catalytic electrodes composed of a metal material having a catalytic action in producing the nano-sized carbon material may be installed inside the discharge vessel. Yet further, catalyzers each composed of a metal material having a catalytic action in producing the nano-sized carbon material are preferably installed inside the discharge vessel. Furthermore, temperature regulating means for adjusting surface temperature of the catalytic electrodes or the catalyzers may be installed. Still further, magnetic field producing means installed outside of the discharge vessel, for producing a magnetic field inside the discharge vessel, are preferably provided.

### EFFECT OF THE INVENTION

With the invention having those features in configuration, by impressing ACs with a phase difference shifted from each other on the discharge electrodes, respectively, in an insert gas atmosphere, and causing the arc discharges to occur, thereby forming a stable plasma region, the nano-sized carbon material excellent in quality can be produced from the carbon raw material by use of the plasma region formed by the arc discharges. More specifically, the plasma region is formed by the arc discharges that occur by impressing ACs with the phase difference shifted from each other on the not less than three pieces of the discharge electrodes disposed in two dimensions or three dimensions, respectively, and because the central part of the plasma region becomes very high in temperature (at about 10,273 K), it is possible to stably form a large temperature region higher the carbon vaporization temperature (5,100 K). Accordingly, synthesis of a nano-sized carbon material can be implemented by causing the carbon raw material to be vaporized with reliability, and to be subsequently cooled, so that it is possible to fabricate a high-quality nano-sized carbon material with a few structural defects. With the CVD process, since it has been impossible to vaporize carbon while forming the temperature region as described, higher the carbon vaporization temperature, fabrication of a nano-sized carbon material with many structural defects is unavoidable, but with the invention, since the carbon raw material can be stably vaporized, a nano-sized carbon material as fabricated can be improved in quality. Further, with the conventional arc discharging method using a DC power source, although a plasma region is formed by an arc discharging, a temperature region higher the carbon vaporization temperature is small between a pair of electrodes, and the plasma region cannot be stably formed, so that it has been difficult to stably fabricate a nano-sized carbon material. In contrast, with the invention, the plasma region significantly larger than that for the conventional arc discharging method can be stably formed, so that a nano-sized carbon material can be easily fabricated on a mass production basis.

Further, carbon is fed from the discharge electrodes containing carbon by use of the discharge electrodes, or the insert gas containing the raw material gas is fed into the discharge vessel, thereby enabling the carbon raw material to be reliably fed into the plasma region formed by the arc discharges.

Still further, when using a metal material having a catalytic action in producing the nano-sized carbon material, the metal material serving as a catalyst can be installed inside the discharge vessel with ease by use of the catalytic electrodes containing the metal material, or by installing the catalyzers each composed of the metal material inside the discharge vessel, so that the nano-sized carbon material excellent in quality can be efficiently fabricated. Furthermore, by installing the temperature regulating means for adjusting surface temperature of the catalytic electrodes or the catalyzers, it is possible to cause a catalytic action by the metal material to work in an optimum condition.

Still further, by installing the magnetic field producing means for producing the magnetic field inside the discharge vessel, outside of the discharge vessel, it is possible to confine plasma generated in a predetermined plasma region by the agency of a magnetic field produced inside the discharge vessel, thereby effecting homogenization of temperature and density within the plasma region.

### BEST MODE FOR CARRYING OUT THE INVENTION

Embodiments of the invention are described in detail hereinafter. Since the embodiments described hereinafter represent preferable specific examples subject to various technical limitations in carrying out the invention, it is to be pointed out that the invention is not limited to those embodiments unless otherwise explicitly stated in the following description.

FIG. 1 is a schematic sectional view of an embodiment of the invention. A discharge vessel 1 cylindrical in shape is made up of a metallic vacuum chamber high in air-tightness. Discharge electrodes 10 to 15, and discharge electrodes 20 to 25, each in a bar-like shape, are installed in two tiers, upper tier, and lower tier, respectively, at a side face part 2 of the discharge vessel 1 as described later in the present description. The respective discharge electrodes are installed so as to penetrate through the side face part 2 such that the tips thereof are set to be positioned inside the discharge vessel 1.

If a carbon electrode is used for each of the discharge electrodes, the carbon electrodes can be used in common as the discharge electrodes, and a carbon raw material for a nano-sized carbon material. For the carbon electrodes, use is preferably made of graphite at a purity, for example, 99.995% or higher. Further, when using the carbon electrodes serving as the discharge electrodes, part of the carbon electrodes may be caused to contain a metal material having a catalytic action in producing a nano-sized carbon material. The metal material capable of having the catalytic action includes, for example, nickel (Ni), cobalt (Co), iron (Fe), and so forth. If such a metal material as described is pulverized, and on the order of 10 wt. % thereof is contained in the carbon electrodes, a metal serving as a catalyst is also supplied when carbon is vaporized from the carbon electrodes, thereby enabling synthesis of the nano-sized carbon material to be implemented efficiently. In this connection, use can be made of only one variety of metal material serving as a catalyst, or mixture of a plurality of varieties of metal materials, each serving as a catalyst.

The discharge vessel 1 has a top face part 4 provided with an opening serving as a gas feed inlet 45, to which an inert gas and a raw material gas are fed from a gas feeder. At the gas feeder, an inert gas is fed from a feed tank 40 via a feed valve 42, and a raw material gas is fed from a feed tank 41 via a feed valve 43. Then, the inert gas, and the raw material gas, as fed, are evenly mixed in a mixer 44 to be subsequently guided into the discharge vessel 1 through the gas feed inlet 45. A feed gas is preferably at a pressure in a range of 200 to 600 Torr.

As the inert gas, use is preferably made of gas of substance giving no effect on the synthesis of the nano-sized carbon material, including, for example, helium (He) gas, argon (Ar) gas, and so forth. Further, as the raw material gas serving as a raw material for the nano-sized carbon material, use is preferably made of a hydrocarbon gas, and for example, methane (CH₄), n-hexane (C₆H₁₄), propane (C₃H₈), and so forth are preferable.

Further, the discharge vessel 1 has a bottom face part 5 provided with an opening serving as a gas exhaust outlet 46, through which the gas inside the discharge vessel 1 is discharged by an exhaust pump 47.

With the present embodiment, both the carbon electrodes, and the raw material gas are used as the raw material for the nano-sized carbon material, however, only either thereof can be used instead. In the case where feeding of the raw material gas is stopped, it need only be sufficient to shut down the feed valve 43, and an electro-conductive material other than carbon may be used for the discharge electrodes.

The side face part 2 of the discharge vessel 1 has a cooling void 3 defined between an inner peripheral wall 2a, and an outer peripheral wall 2b, and a cooling medium C is fed from an upper part of the side face part 2 to the cooling void 3 to be discharged from an under part thereof. For the cooling medium C, use can be made of, for example, water, and air.

FIG. 2 is a schematic perspective view showing disposition conditions of the respective discharge electrodes, and FIG. 3 is a sectional view taken on line A-A of FIG. 1. There are 6 pieces of the discharge electrodes 10 to 15, disposed along the horizontal plane in the upper tier, so as to be angularly shifted in the radial direction by 60 degrees from each other, and 6 pieces of the discharge electrodes 20 to 25, disposed along the horizontal plane in the lower tier, so as to be angularly shifted in the radial direction by 60 degrees from each other, similarly to the former. Further, as shown in FIG. 3, the respective discharge electrodes in the lower tier are disposed so as to be angularly shifted by 30 degrees against the respective discharge electrodes in the upper tier. It follows therefore that the 12 pieces of the discharge electrodes are disposed at equal intervals so as to be angularly shifted by 30 degrees from each other as seen from above. Further, the respective discharge electrodes are set such that the tips thereof are at an equidistance from the center axis 0 of the inner peripheral wall 2a of the side face part 2.

There is provided a sealing member 16 around junctions between the respective discharge electrodes 10 to 15, and the side face part 2, respectively, and electrical insulation between the respective discharge electrodes, and the discharge vessel 1 is thereby maintained with the respective sealing members 16. The respective discharge electrodes 20 to 25 are similarly provided with a sealing member 26.

Further, as shown in FIG. 3, catalyzers 7 made of a catalyst metal, in a plate-like shape, are fixedly attached to the inner surface of the inner peripheral wall 2a. The catalyzers are each composed of the metal material having the catalytic action in producing the nano-sized carbon material as described in the foregoing. Because the catalyzers are installed so as to come into face contact with the inner peripheral wall 2a, as the inner peripheral wall 2a is cooled down by the agency of the cooling medium, so surface temperature of the catalyzers 7 drops accordingly. Hence, by adjusting a flow rate and temperature of the cooling medium, the surface temperature of the catalyzers 7 also can be adjusted. In this example, use is made of the catalyzers 7 formed in the plate-like shape, however, there is no particular limitation to the shape thereof. A catalyst metal may be used for a constituent material of the inner peripheral wall 2a, thereby rendering the inner peripheral wall 2a, in its entirety, to serve as the catalyzer, and the respective inner surfaces of the top face part 4, and the bottom face part 5 of the discharge vessel 1 may be composed of a catalyst metal.

The respective discharge electrodes are connected to an AC power source 30, and ACs each having a phase difference for every discharge electrode are impressed on the respective discharge electrodes. The AC power source 30 has a function for converting 3-phase AC for commercial use into 12-phase AC, and a conversion circuit diagram thereof is shown in FIG. 4. Further, a connection diagram using six transformers is shown in FIG. 5.

As shown in FIG. 4, the AC power source 30 is comprised of a 3-phase to 6-phase conversion transformer 31, and a 3-phase to 6-phase conversion transformer 32. With the 3-phase to 6-phase conversion transformer 31, a turn ratio of a primary coil to a secondary coil is at 1:1, and three single-phase transformers T1 to T3, each having an intermediate tap on the secondary coil, are used while the primary coils of the respective transformers are connected with each other by means of a star connection. Further, with the 3-phase to 6-phase conversion transformer 32, a turn ratio of a primary coil to a secondary coil is at 1:1/\sqrt{3}, and three single-phase transformers T4 to T6, each having an intermediate tap on the secondary coil, are used while the primary coils of the respective transformers are connected with each other by means of a delta connection. Then, the six pieces of the single-phase transformers T1 to T6 are connected with each other by use of the intermediate tap on the secondary coil of each of the single-phase transformers as a center point.

The 3-phase AC for commercial use is delivered to input terminals R, S, and T of the AC power source 30, respectively. Upon delivery of the 3-phase AC, the following voltages are outputted to output terminals 10′ to 15′ of the 3-phase to 6-phase conversion transformer 31, respectively.

<terminal> <voltage>

10′ Vₓ

11′ V_{z}′

12′ V_{y}

13′ Vₓ′

14′ V_{z}

15′ V_{y}′

The respective voltages are found by the following expressions (1) and (2) on the basis of time t. Further, Vₘ is the maximum voltage value of a commercial power source, and ω is an angular frequency calculated from the frequency of the commercial power source.

$${V}_{i} = {V}_{m} sin ( ω t - \frac{n}{3} π ) , ( i = x , y , z ) , ( n = 0 , 2 , 4 ) \qquad Expression ( 1 )$$

δ

$${V}_{i} = {V}_{m} sin ( ω t - \frac{n}{3} π ) , ( i = x , y , z ) , ( n = 1 , 3 , 5 ) \qquad Expression ( 2 )$$

Similarly, the following voltages are outputted to output terminals 20′ to 25′ of the 3-phase to 6-phase conversion transformer 32, respectively.

<terminal> <voltage>

20′ Vₓδ

21′ V_{z}′δ

22′ V_{y}δ

23′ Vₓ′δ

24′ V_{z}δ

25′ V_{y}′δ

The respective voltages are found by the following expressions (3) and (4) on the basis of time t.

$${V}_{i} δ = {V}_{m} sin ( ω t - \frac{n}{6} π ) , ( i = x , y , z ) , ( n = 1 , 5 , 9 ) \qquad Expression ( 3 )$$

$${V}_{i} δ = {V}_{m} sin ( ω t - \frac{n}{6} π ) , ( i = x , y , z ) , ( n = 7 , 11 , 15 ) \qquad Expression ( 4 )$$

On the basis of the above, a voltage Vi represented by the following expression (5) is outputted to the 12 pieces of the output terminals, respectively.

$${V}_{i} = {V}_{m} sin ( ω t - \frac{i - 1}{6} π ) , ( i = 1 … 12 ) \qquad Expression ( 5 )$$

Accordingly, ACs with a phase difference shifted by π/6 from each other are outputted to the 12 pieces of the output terminals, respectively. When the output terminals 10′ to 15′ are connected to the discharge electrodes 10 to 15, respectively, and the output terminals 20′ to 25′ are connected to the discharge electrodes 20 to 25, respectively, this will cause ACs each with a predetermined phase difference shifted from each other to be impressed on the discharge electrodes, respectively. By disposing the discharge electrodes taking into account a relationship of a distance between the respective discharge electrodes with the phase difference between the respective discharge electrodes, it becomes possible to reduce a fluctuation ratio of overall power down to the order of several percent, thereby enabling the fluctuation ratio substantially at the same level as that for the conventional arc discharging by the DC power source to be attained.

With the embodiment described as above, the discharge electrodes are disposed in three dimensions by disposing the same in two tiers, however, the 12 pieces of the discharge electrodes each may be disposed in two dimensions by angularly shifting the same by 30 degrees from each other along the horizontal plane. Further, one unit may be made up of the discharge electrodes that are disposed in two tiers, and the AC power source 30, and a plurality of the units may be disposed in the vertical direction. The units may be set up as appropriate according to a size of a plasma region as required.

By impressing AC voltages on the discharge electrodes configured as described above, respectively, an arch discharge is caused to occur between the respective discharge electrodes, whereupon there is produced a plasma region 6 as shown in FIGS. 1 to 3, respectively. The plasma region 6 is three-dimensionally formed in a region surrounded by the respective discharge electrodes, and the central part thereof can be rendered to be in a high-temperature state at about 10,273 K. The farther away from the central part, the lower the temperature of a portion of the plasma region 6 becomes, and a temperature region higher than the carbon vaporization temperature (5,100 K) can be stably formed. Further, the cooling medium flows along the side face part 2 of the discharge vessel 1, so that temperature of the plasma region 6, at the peripheral portion thereof, is regulated so as not to excessively rise.

Then, as shown in FIG. 6, if 4 pieces of permanent magnets 50 to 53 are attached to the discharge vessel 1 along the side face part 2 thereof, and between the respective discharge electrodes in the two tiers (indicated by dotted lines) and the permanent magnets are set such that respective magnetic poles of the permanent magnets opposing each other are of the same polarity, a magnetic field (lines of magnetic force are schematically shown by arrows in the figure) is produced inside the discharge vessel 1, thereby confining plasma as much as possible so as not to be dispersed out of the plasma region, so that it is possible to homogenize the temperature and density of the plasma region.

As carbon, vaporized in the plasma region as formed, moves closer to the periphery of the plasma region, so temperature in the plasma region becomes lower, so that the carbon is synthesized into a nano-sized carbon material to be subsequently adhered to the entire inner face of the discharge vessel 1. Thereafter, after completion of the arc discharging, the nano-sized carbon material is recovered from soot adhered to the inner face by the public known method.

### WORKING EXAMPLE

In an apparatus for fabricating a nano-sized carbon material, shown in FIG. 1, for the discharge vessel 1, use was made of a stainless steel vacuum chamber (manufactured by Fukushin Industries Co., Ltd.). First, air was evacuated from the vacuum chamber by an evacuation pump, and subsequently, a helium (He) gas (at purity 99.99%) was fed therein until a pressure reached 600 Torr. In this case, a raw material gas was not fed.

For the discharge electrodes, use was made of a 99.995% pure graphite formed in the shape of a bar 500 mm long, and 12 mm in diameter. As with the case of the apparatus shown in FIG. 1, there were installed 12 pieces of the discharge electrodes, 6 pieces each being disposed in two tiers. The discharge electrodes were disposed such that those in the upper tier are away by a distance about 160 mm from those in the lower tier. First to sixth pieces of those discharge electrodes are added with 10 wt. % of nickel (Ni) serving as a catalyst metal, and further, catalyzers made of nickel (Ni), formed in a plate-like shape, are fixedly attached to the inner surface of the vacuum chamber.

When inducing arc discharges, an arc discharging was started with the respective discharge electrodes being kept in a state where the respective tips thereof are in contact with each other while impressing ACs with a phase difference, respectively, (at a voltage in the range of 20 to 40V, and at a current strength in the range of 70 to 100 A) on the respective discharge electrodes. After occurrence of the arc discharges, the respective discharge electrodes were moved outward such that the respective tips thereof were caused to part from each other, and the respective discharge electrodes were set to positions where a distance between the respective tips of the discharge electrodes opposed to each other was in the range of 5 to 10 mm, thereby continuously inducing the arc discharge.

After having induced the arc discharge for a time period of about 10 minutes to one hour, impressing of the voltages from the AC power source was stopped, also stopping feeding of a gas. Thereafter, a soot-like matter adhered to the inner face of the vacuum chamber was recovered.

FIG. 7 shows results of observations on the soot-like matter as recovered, made with the use of a scanning electron microscope (SEM). As is obvious from a photograph in FIG. 7, a multitude of string-like matters were observed. FIG. 8 shows results of observations on the string-like matters, made with the use of a transmission electron microscope (TEM). In from a photograph in FIG. 8, a lamellar structure that is the feature of a multilayered carbon nanotube can be definitely observed and the multilayered carbon nanotube had a diameter in the range of 20 to 40 nm. FIG. 9 shows results of analyses on the string-like matters, made with the use of a Raman spectrometry using the 514.5 nm Ar⁺ laser. With a graph in FIG. 9, the vertical axis represents intensity, and the horizontal axis represents wavelength. In the graph, a spike appears at G-band (1,580 cm-1) and D-band (1,360 cm-1) respectively, and since a carbon nanotube generally shows itself at G-band, it is definitely shown that synthesis of the carbon nanotube was implemented.

The inventor, et al. disposed a stainless steel sheet in the plasma region produced by the discharge electrodes to observe a temperature condition of the plasma region, whereupon the stainless steel sheet was found melted in the central part thereof, thereby indicating that the central part was in a temperature condition higher than 1,675 K, that is, the melting temperature of stainless steel. In addition, it was confirmed on the basis of a distribution condition of a carbon nanotube composed of a soot-like matter adhered to the stainless steel sheet that a large quantity of the carbon nanotube excellent in quality was synthesized in a temperature range of 1,273 to 1,523 K. The temperature range described was found spherically expanded away from the central part by 50 to 100 nm within the plasma region, and by putting the wide temperature range to use for synthesis of a nano-sized carbon material, it is possible to fabricate the nano-sized carbon material on a significantly large scale production basis as compared with a conventional method for fabrication. Furthermore, because the nano-sized carbon material is fabricated after vaporizing carbon for once, it is possible to fabricate the nano-sized carbon material high in purity and excellent in quality.

### BRIEF DESCRIPTION OF THE DRAWINGS

FIG. 1 A schematic sectional view of an embodiment of the invention.

FIG. 2 A schematic perspective view showing disposition conditions of respective discharge electrodes.

FIG. 3 A sectional view taken on line A-A of FIG. 1.

FIG. 4 A conversion circuit diagram of an AC power source.

FIG. 5 A connection diagram using transformers of the AC power source.

FIG. 6 A sectional view illustrating actions of permanent magnets.

FIG. 7 A photograph taken by a scanning electron microscope (SEM), showing results of observations.

FIG. 8 A photograph taken by a transmission electron microscope (TEM), showing results of observations.

FIG. 9 A graph showing results of analyses made with the use of a an spectrometry.

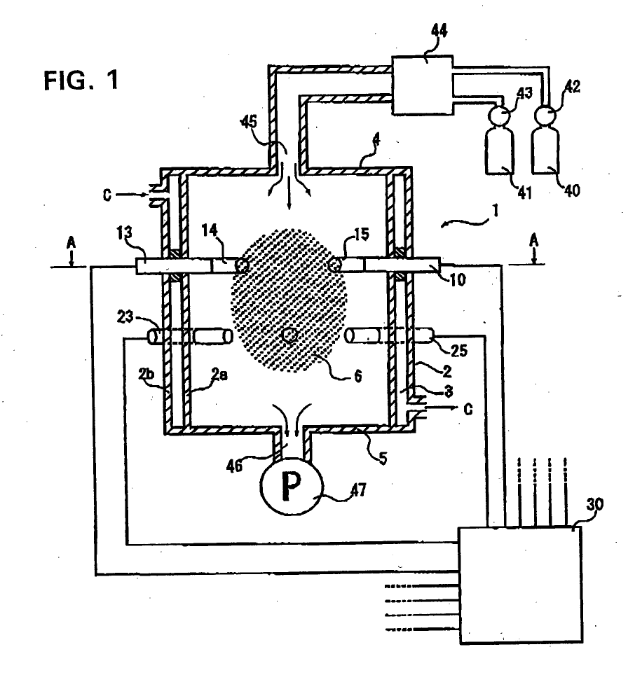

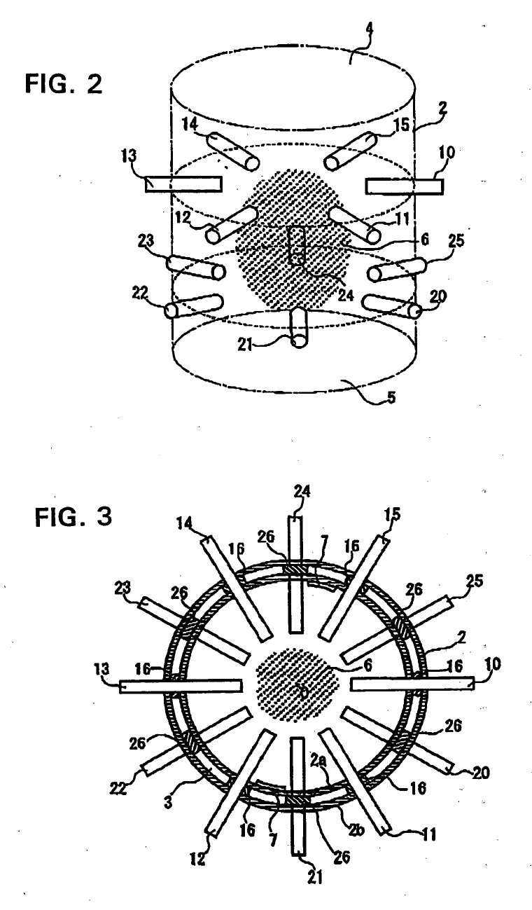

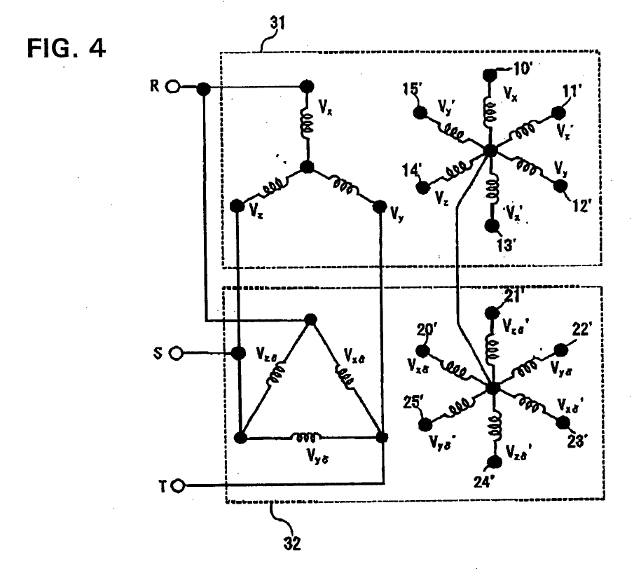

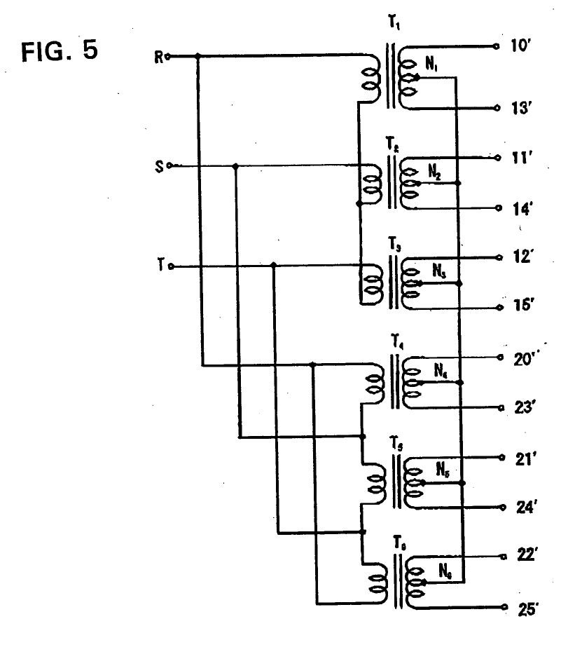

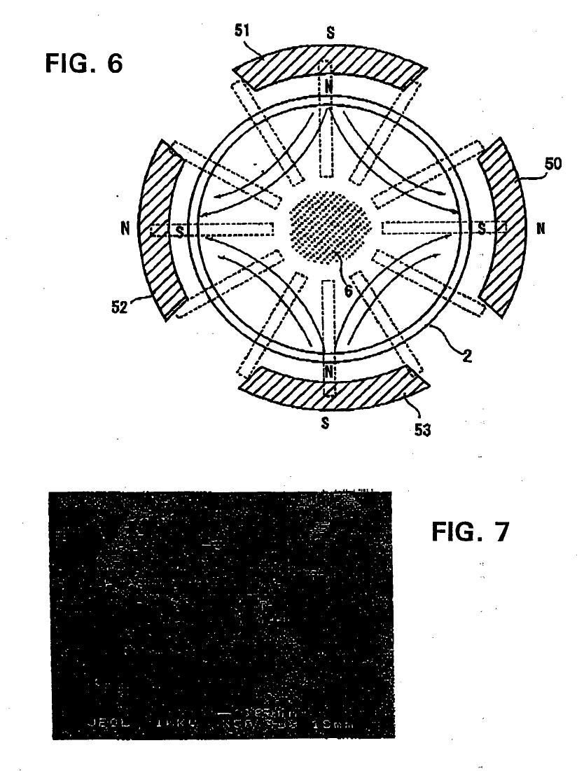

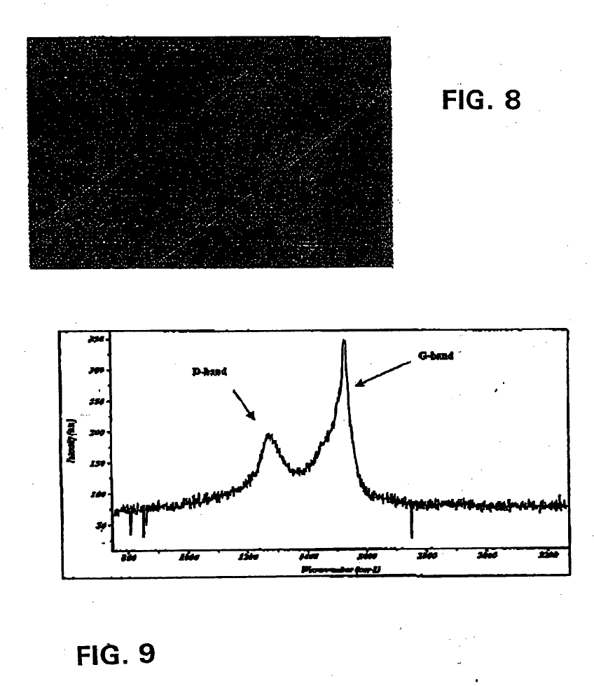

### EXPLANATION OF NUMERALS

1 discharge vessel
2 side face part
3 cooling void 3
4 top face part
5 bottom face part
6 plasma region
7 catalyzers
10, 11, 12, 13, 14, 15 discharge electrodes in upper tire
20, 21, 22, 23, 24, 25 discharge electrodes in lower tire
30 ac power source
40 feed tank
41 feed tank
42 feed valve
43 feed valve
44 mixer
45 gas feed inlet
46 gas exhaust outlet
47 exhaust pump
50, 51, 52, 53 permanent magnets

1. A method of fabricating a nano-sized carbon material comprising the steps of preparing not less than three pieces of discharge electrodes disposed in two dimensions or three dimensions, impressing acs with a phase difference shifted from each other on the not less than three pieces of the discharge electrodes, respectively, in an insert gas atmosphere, thereby causing arc discharges to occur, and producing the nano-sized carbon material from a carbon raw material by use of a plasma region formed by the arc discharges.

2. A method of fabricating a nano-sized carbon material according to claim 1, wherein the carbon raw material is carbon contained in the discharge electrodes.

3. A method of fabricating a nano-sized carbon material according to claim 1, wherein the carbon raw material is a raw material gas contained in the insert gas.

4. A method of fabricating a nano-sized carbon material according to claim 1, wherein a metal material having a catalytic action is used in producing the nano-sized carbon material.

5. An apparatus for fabricating a nano-sized carbon material comprising a discharge vessel where not less than three pieces of carbon discharge electrodes are disposed in two dimensions or three dimensions, a gas feeder for feeding an inert gas into the discharge vessel, and an AC power source for impressing ACs with a phase difference shifted from each other on the carbon discharge electrodes, respectively, thereby causing an arc discharge to occur between the respective carbon discharge electrodes.

6. An apparatus for fabricating a nano-sized carbon material comprising a discharge vessel where not less than three pieces of discharge electrodes are disposed in two dimensions or three dimensions, a gas feeder for feeding an inert gas containing a raw material gas into the discharge vessel, and an AC power source for impressing ACs with a phase difference shifted from each other on the discharge electrodes, respectively, thereby causing an arc discharge to occur between the respective discharge electrodes.

7. An apparatus for fabricating a nano-sized carbon material according to claim 5, wherein catalytic electrodes composed of a metal material having a catalytic action in producing the nano-sized carbon material is installed inside the discharge vessel.

8. An apparatus for fabricating a nano-sized carbon material according to claim 5, wherein catalyzers each composed of a metal material having a catalytic action in producing the nano-sized carbon material are installed inside the discharge vessel.

9. An apparatus for fabricating a nano-sized carbon material according to claim 8, wherein temperature regulating means for adjusting surface temperature of the catalytic electrodes is installed.

10. An apparatus for fabricating a nano-sized carbon material according to claims 5, wherein magnetic field producing means installed outside of the discharge vessel, for producing a magnetic field inside the discharge vessel, are provided.
